(19) United States
(12) Patent Application Publication
(10) Pub. No.: US 2026/0017127 A1
(43) Pub. Date: Jan. 15, 2026

(54) STORAGE REGION MANAGEMENT METHOD AND STORAGE DEVICE

(71) Applicant: Hefei Kaimeng Technology Co., Ltd., Anhui (CN)

(72) Inventors: Xiao Yang ZHANG, Anhui (CN); Kaidi ZHU, Anhui (CN); Zhi WANG, Anhui (CN); Tsung-Lin Wu, Anhui (CN); Qiao ZHU, Anhui (CN)

(73) Assignee: Hefei Kaimeng Technology Co., Ltd., Anhui (CN)

(21) Appl. No.: 19/063,246

(22) Filed: Feb. 25, 2025

(30) Foreign Application Priority Data
Jul. 12, 2024 (CN) 202410931426.2

(51) Int. Cl. G06F 11/07; G06F 11/27

(52) U.S. Cl. CPC G06F 11/0772; G06F 11/0793; G06F 11/27

(57) ABSTRACT

A storage region management method and a storage device are provided. The method includes the following steps. An error event related to a first physical unit is detected. The first physical unit is classified as a first-type storage region according to the error event. According to a state description information related to the error event, a storage region verification is performed on the first physical unit classified as the first-type storage region. When a result of the storage region verification does not meet a recovery conditions, the first physical unit is determined as a second-type storage region. As a result, an accuracy of determining the second-type storage region may be improved, achieving an effect of extending a service life of the storage device.

### CROSS-REFERENCE TO RELATED APPLICATION

This application claims the priority benefit of China application serial no. 202410931426.2, filed on Jul. 12, 2024. The entirety of the above-mentioned patent application is hereby incorporated by reference herein and made a part of this specification.

### BACKGROUND

### Technical Field

The disclosure relates to the field of storage technology, and in particular to a storage region management method and a storage device.

### Description of Related Art

In applications involving automotive-grade storage chips, the complex environment in which vehicles operate may cause storage chips to run under some extreme application scenarios, such as high-temperature and low-temperature environments.

Under these extreme application scenarios, the number of error bits in the data read from the storage chip may increase dramatically, resulting in a large number of physical blocks being determined as bad blocks and becoming unusable. Over time, the number of available physical blocks in the storage chip will decrease sharply, thereby shortening the service life of the storage device.

Therefore, there is an urgent need for a storage region management method to solve the above problem.

### SUMMARY

A storage region management method and a storage device are provided. The storage region management method and the storage device may effectively improve the issue of a significant increase in the number of second-type storage regions (e.g., bad blocks) caused by frequent exposure of the storage device to extreme operating environments. By improving the accuracy of determining the second-type storage region, the service life of the storage device is extended.

An embodiment of the disclosure provides a storage region management method used for a storage device. The storage device includes a memory module, and the memory module includes a multiple physical units. The storage region management method includes the following steps. An error event related to a first physical unit of the physical units is detected. The first physical unit is classified as a first-type storage region according to the error event. According to a state description information related to the error event, a storage region verification is performed on the first physical unit classified as the first-type storage region. When a result of the storage region verification does not meet a recovery conditions, the first physical unit is determined as a second-type storage region.

Another embodiment of the disclosure provides a storage device, which includes a connection interface, a memory module, and a memory controller. The connection interface is connected to a host system. The memory controller is connected to the connection interface and the memory module. The memory controller is used to: detect an error event related to a first physical unit of the physical units; classify the first physical unit as a first-type storage region according to the error event; according to a state description information related to the error event, perform a storage region verification on the first physical unit classified as the first-type storage region; and when a result of the storage region verification does not meet a recovery conditions, determine the first physical unit as a second-type storage region.

Based on the above, the storage region management method and the storage device allow the first physical unit to be initially classified as a first-type storage region before being determined as a second-type storage region. After the operating environment becomes relatively stable, a storage region verification is performed on the first physical unit classified as the first-type storage region. According to the result of the storage region verification, the first physical unit may be reclassified as a third-type storage region or determined as a second-type storage region. This effectively mitigates the problem of a significant increase in the number of second-type storage regions (e.g., bad blocks) traditionally caused by frequent operation of the storage device in extreme environments, thereby achieving the effect of extending the service life of the storage device.

### BRIEF DESCRIPTION OF THE DRAWINGS

FIG. 1 is a schematic diagram of a data storage system shown according to an embodiment of the disclosure.

FIG. 2 is a schematic diagram of a memory controller shown according to an embodiment of the disclosure.

FIG. 3 is a schematic diagram of managing a memory module shown according to an embodiment of the disclosure.

FIG. 4 is a schematic diagram of reclassifying a first physical unit as a third-type storage region shown according to an embodiment of the disclosure.

FIG. 5 is a schematic diagram of determining a first physical unit as a second-type storage region shown according to an embodiment of the disclosure.

FIG. 6 is a schematic diagram of state description information related to an error event shown according to an embodiment of the disclosure.

FIG. 7 is a flowchart of a storage region management method shown according to an embodiment of the disclosure.

FIG. 8 is a flowchart of a storage region management method shown according to an embodiment of the disclosure.

### DESCRIPTION OF THE EMBODIMENTS

The exemplary embodiments of the disclosure will now be described in detail with reference to the drawings. Examples of the exemplary embodiments are illustrated in the attached drawings. Wherever possible, identical reference numerals are used in the drawings and description to denote identical or similar parts.

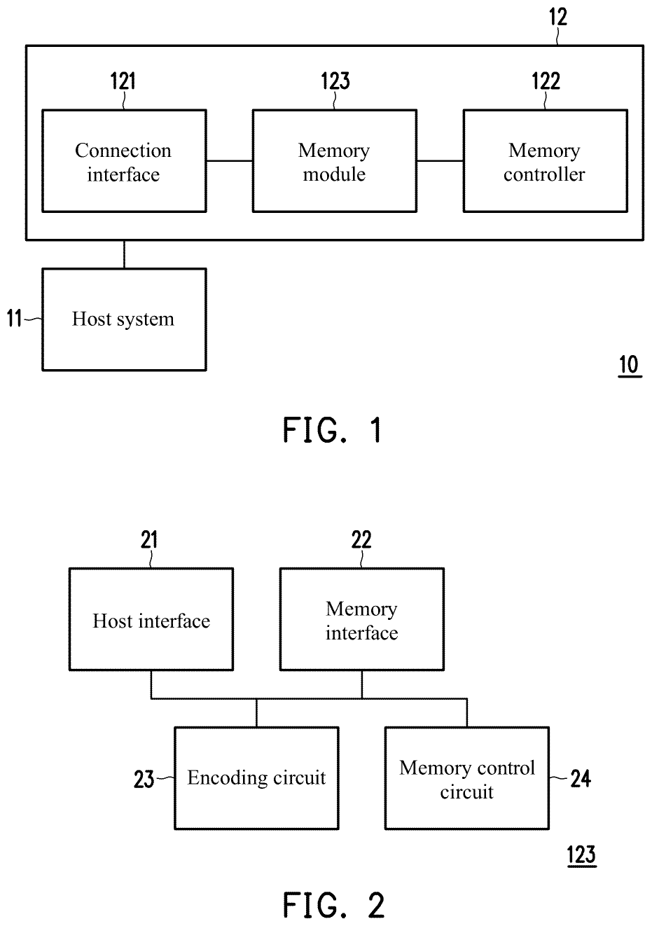

FIG. 1 is a schematic diagram of a data storage system according to an embodiment of the disclosure. Referring to FIG. 1, the data storage system 10 includes a host system 11 and a storage device 12. The storage device 12 may be connected to the host system 11 and may be used to store data from the host system 11. For example, the host system 11 may be a smartphone, a tablet computer, a laptop computer, a desktop computer, an industrial computer, a game console, a server, or a computer installed on a specific carrier, and the type of the host system 11 is not limited thereto. In addition, the storage device 12 may include a solid-state drive, a USB drive, a memory card, or other types of non-volatile storage devices.

In an embodiment, the data storage system 10 is suitable for being disposed in carriers such as vehicles, aircraft, or machine rooms, where the operating environment is prone to extreme changes. In an embodiment, the extreme changes of the operating environment may refer to large variations in the temperature of the carrier, large variations in the amplitude of the carrier's vibration, large variations in the frequency of the carrier's vibration, and/or large variations in the posture of the carrier. In an embodiment, the data storage system 10 may also be disposed in other types of operating environments, and the disclosure is not limited thereto.

The storage device 12 includes a connection interface 121, a memory module 122, and a memory controller 123. The connection interface 121 is used to connect the storage device 12 to the host system 11. For example, the connection interface 121 may support embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Therefore, the storage device 12 may communicate (e.g., exchange signals, commands, and/or data) with the host system 11 via the connection interface 121.

The memory module 122 is used to store data. For example, the memory module 122 may include one or more rewritable non-volatile memory modules. Each rewritable non-volatile memory module may include one or more memory cell arrays. The memory cells in the memory cell arrays store data in the form of voltage (also referred to as a threshold voltage). For example, the memory module 122 may include single level cell (SLC) NAND flash memory modules, multi level cell (MLC) NAND flash memory modules, triple level cell (TLC) NAND flash memory modules, quad level cell (QLC) NAND flash memory modules, and/or other memory modules with the same or similar characteristics.

The memory controller 123 is connected to the connection interface 121 and the memory module 122. The memory controller 123 may be regarded as the control core of the storage device 12 and is used to control the storage device 12. For example, the memory controller 123 may be used to control or manage the overall or partial operations of the storage device 12. For example, the memory controller 123 may include a central processing unit (CPU), or other programmable general-purpose or special-purpose microprocessors, digital signal processors (DSP), programmable controllers, application specific integrated circuits (ASIC), programmable logic devices (PLD), or other similar devices, or combinations of these devices. In an embodiment, the memory controller 123 may include a flash memory controller.

The memory controller 123 may send instruction sequences to the memory module 122 to access the memory module 122. The memory module 122 may receive the instruction sequences from the memory controller 123 and access the memory cells inside the memory module 122 according to the instruction sequences. For example, the memory controller 123 may send a write instruction sequence to the memory module 122 to instruct the memory module 122 to store data in specific memory cells. For example, the memory controller 123 may send a read instruction sequence to the memory module 122 to instruct the memory module 122 to read data from specific memory cells. For example, the memory controller 123 may send an erase instruction sequence to the memory module 122 to instruct the memory module 122 to erase data stored in specific memory cells. In addition, the memory controller 123 may send other types of instruction sequences to the memory module 122 to instruct the memory module 122 to perform other types of operations, and the disclosure is not limited thereto.

FIG. 2 is a schematic diagram of the memory controller according to an embodiment of the disclosure. Referring to FIGS. 1 and 2, the memory controller 123 includes a host interface 21, a memory interface 22, an encoding circuit 23, and a memory control circuit 24. The host interface 21 is used to connect to the host system 11 through the connection interface 121 to communicate with the host system 11. The memory interface 22 is used to connect to the memory module 122 to access the memory module 122.

The encoding circuit 23 is used to encode data to be stored in the memory module 122. For example, the encoding circuit 23 may add an Error Correction Code (ECC) to a piece of data to form an ECC frame. This ECC frame may be stored in the memory module 122. When reading data, this ECC frame may be read out, and the ECC in the ECC frame may be used to correct error bits in the corresponding data. For example, the encoding circuit 23 may use a low density parity check code (LDPC code), BCH code, Reed-Solomon code (RS code), exclusive OR (XOR) code, or others. In an embodiment, the encoding circuit 23 may include an error checking and correcting circuit or other circuits with similar data encoding and decoding functions.

The memory control circuit 24 is connected to the host interface 21, the memory interface 22, and the encoding circuit 23. The memory control circuit 24 may be used to control or manage the overall or partial operations of the memory controller 123. For example, the memory control circuit 24 may communicate with the host system 11 through the host interface 21 and access the memory module 122 through the memory interface 22. In addition, the memory control circuit 24 may control or instruct the encoding circuit 23 to encode and decode data. For example, the memory control circuit 24 may include a control circuit such as an embedded controller or a microcontroller. In the following embodiments, the description of the memory control circuit 24 is equivalent to the description of the memory controller 123.

In an embodiment, the memory controller 123 may further include a buffer memory and a power management circuit. The buffer memory is used to buffer data. The power management circuit is used to manage the power of the storage device 12. In an embodiment, the memory controller 123 may also include other types of circuit modules, and the disclosure is not limited thereto.

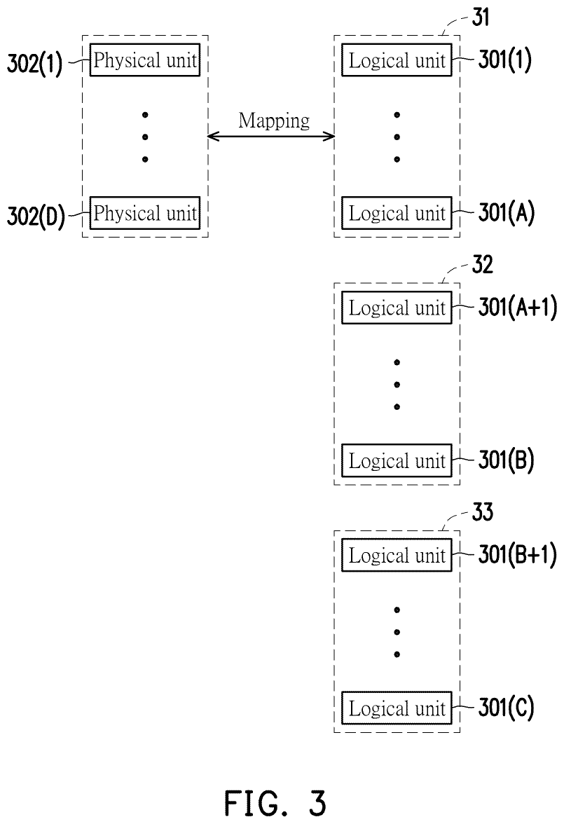

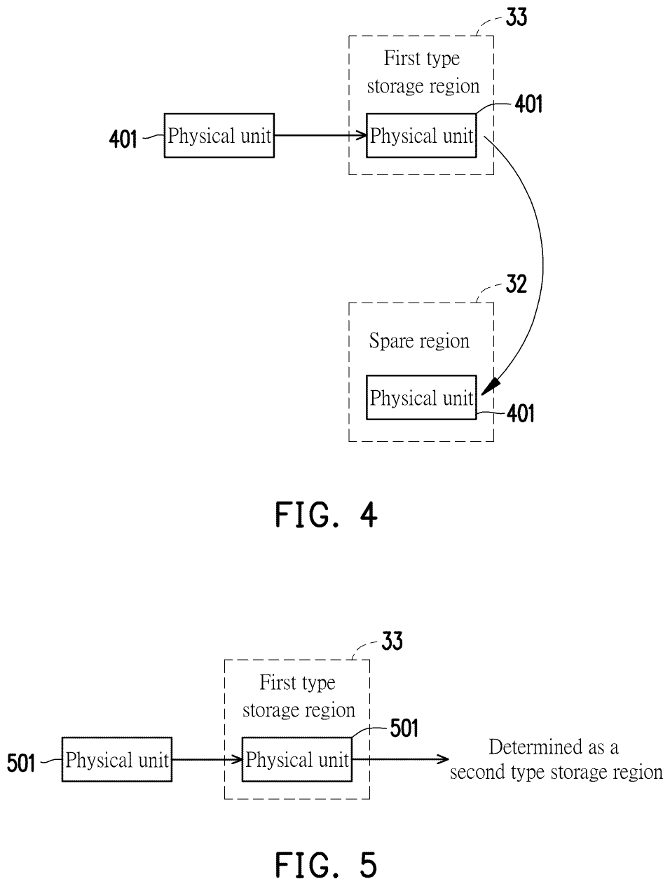

FIG. 3 is a schematic diagram of managing the memory module according to an embodiment of the disclosure. Referring to FIGS. 1 to 3, the memory module 122 includes a plurality of physical units 301(1) to 301(C). Each physical unit includes multiple memory cells and is used to non-volatilely store data.

In an embodiment, a physical unit may include one or more physical erase units. A physical erase unit may include multiple physical programmable units. A physical programmable unit may include multiple physical sectors. For example, the data capacity of a physical sector may be 512 bytes (B), and a physical programmable unit may include 8 physical sectors. However, the data capacity of a physical sector and/or the total number of physical sectors included in a physical programmable unit may be adjusted according to practical requirements, and the disclosure is not limited thereto. In an embodiment, a physical programmable unit may be regarded as a physical page. For example, the data capacity of a physical programmable unit may be 4 kilobytes (4 KB), and the disclosure is not limited thereto.

In an embodiment, a physical programmable unit is the smallest unit for synchronously writing data in the memory module 122. For example, when performing a programming operation (also referred to as a write operation or data write operation) on a physical programmable unit to write data into this physical programmable unit, multiple memory cells within this physical programmable unit may be synchronously programmed to store the corresponding data. For example, when programming a physical programmable unit, a write voltage may be applied to the physical programmable unit to change the threshold voltage of at least some memory cells within the physical programmable unit. The threshold voltage of each memory cell may reflect the bit data stored in the memory cell.

In an embodiment, multiple physical programmable units within a physical erase unit may be synchronously erased. For example, when performing an erase operation on a physical erase unit, an erase voltage may be applied to multiple physical programmable units within this physical erase unit to change the threshold voltage of at least some memory cells within these physical programmable units. By performing the erase operation on a physical erase unit, the data stored in this physical erase unit may be cleared.

In an embodiment, the memory control circuit 24 may logically associate physical units 301(1) to 301(A) with a data region 31 and associate physical units 301 (A+1) to 301(B) with a spare region 32. The physical units 301(1) to 301(A) in the data region 31 are used to store data from the host system 11 (also referred to as user data). For example, each physical unit in the data region 31 may store valid data and/or invalid data. In addition, the physical units 301 (A+1) to 301(B) in the spare region 32 do not store data (i.e., valid data).

In an embodiment, if a physical unit does not store valid data, this physical unit may be associated with the spare region 32. In an embodiment, the spare region 32 is also referred to as a free pool. Additionally, the physical units associated with the spare region 32 may be erased to clear the data within these physical units.

In an embodiment, when there is data from the host system 11 (i.e., user data) that needs to be stored, the memory control circuit 24 may select one or more physical units from the spare region 32 and instruct the memory module 122 to store the data from the host system 11 into the selected physical units. At the same time, the selected physical units may be associated with the data region 31.

In an embodiment, the memory control circuit 24 may configure multiple logical units 302(1) to 302(C) to map the physical units 301(1) to 301(A) in the data region 31. For example, a logical unit may correspond to a Logical Block Address (LBA) or other logical management units. A logical unit may map to one or more physical units in the data region 31.

In an embodiment, if a physical unit is currently mapped by any logical unit, the memory control circuit 24 may determine that the physical unit currently stores valid data. Conversely, if a physical unit is not currently mapped by any logical unit, the memory control circuit 24 may determine that the physical unit currently does not store any valid data.

In an embodiment, the memory control circuit 24 may record the mapping relationship between logical units and physical units in a logical-to-physical mapping table. When receiving an access command from the host system 11 (e.g., a read command, a write command, a delete command, or other types of commands), the memory control circuit 24 may instruct the memory module 122 to perform the corresponding operation according to the information in the logical-to-physical mapping table.

In an embodiment, before determining that at least one physical unit (also referred to as the first physical unit) in the memory module 122 (e.g., the data region 31 or the spare region 32) is a second-type storage region, the memory control circuit 24 may classify the first physical unit as a first-type storage region.

The first-type storage region is used to indicate that the first physical unit is a storage region that may be faulty and requires further verification. The second-type storage region is used to indicate that the first physical unit is a storage region that is determined to be faulty.

In an embodiment, the memory control circuit 24 may associate the first physical unit classified as a first-type storage region with a first-type storage region 33, making the first physical unit at least one of the physical units 301 (B+1) to 301(C) shown in FIG. 3. For example, in the embodiment of FIG. 3, the physical units 301 (B+1) to 301(C) associated with the first-type storage region 33 all belong to the first-type storage region. In an embodiment, the first-type storage region 33 is also referred to as a temporary bad block area.

In an embodiment, after classifying the first physical unit as a first-type storage region, the memory control circuit 24 may disallow (or prohibit) performing a data write operation on the first physical unit belonging to the first-type storage region. For example, the data write operation is used to write data into the first physical unit. In an embodiment, the memory control circuit 24 may disallow (or prohibit) performing a data write operation on any of the physical units 301 (B+1) to 301(C) belonging to the first-type storage region.

In an embodiment, after classifying the first physical unit as a first-type storage region, the memory control circuit 24 may reclassify the first physical unit as a third-type storage region. For example, the memory control circuit 24 may associate the first physical unit reclassified as a third-type storage region with the spare region 32. For example, in the embodiment of FIG. 3, the physical units associated with the data region 31 and the spare region 32 all belong to the third-type storage region. In an embodiment, after reclassifying the first physical unit as a third-type storage region, the memory control circuit 24 may allow the first physical unit to perform regular data write operations.

The third-type storage region is used to indicate that the first physical unit is a normally usable physical unit (i.e., a storage region that is not faulty).

FIG. 4 is a schematic diagram of reclassifying the first physical unit as a third-type storage region according to an embodiment of the disclosure. Referring to FIG. 4, assume that a physical unit 401 is the first physical unit. In an embodiment, after classifying the physical unit 401 as a first-type storage region and associating the physical unit 401 with the first-type storage region 33, the memory control circuit 24 may reclassify the physical unit 401 as a third-type storage region and associate the physical unit 401 with the spare region 32.

In an embodiment, after classifying the first physical unit as a first-type storage region, the memory control circuit 24 may further determine that the first physical unit is a second-type storage region. If the first physical unit is determined to be a second-type storage region, the memory control circuit 24 may remove the association between the first physical unit and the first-type storage region 33. In addition, after determining that the first physical unit is a second-type storage region, the memory control circuit 24 may no longer use the first physical unit to store data. For example, after determining that the first physical unit is a second-type storage region, the memory control circuit 24 may disallow (or prohibit) performing any data write operation on the first physical unit.

In an embodiment, by removing the association between the first physical unit and the first-type storage region 33 and simultaneously applying write operation restrictions on the first physical unit belonging to the second-type storage region, the stability of data writing may be improved. This, in turn, may achieve the effect of enhancing the overall data storage quality of the memory module 122.

FIG. 5 is a schematic diagram of determining the first physical unit as a second-type storage region according to an embodiment of the disclosure. Referring to FIG. 5, assume that a physical unit 501 is the first physical unit. In an embodiment, after classifying the physical unit 501 as a first-type storage region and associating the physical unit 501 with the first-type storage region 33, the memory control circuit 24 may further determine that the physical unit 501 is a second-type storage region and remove the physical unit 501 from the first-type storage region 33 (equivalent to removing the association between the physical unit 501 and the first-type storage region 33).

In an embodiment, after determining that the first physical unit is a second-type storage region, the memory control circuit 24 may perform a data migration operation on the first physical unit. This data migration operation may be used to migrate at least part of the data (i.e., valid data) stored in the first physical unit to other physical units for storage.

Thus, the migrated data may continue to be accessed without needing to be re-acquired from the host system 11, thereby ensuring the efficiency and continuity of data write operations.

In an embodiment, after determining that the first physical unit is a second-type storage region, the memory control circuit 24 may remove any mapping relationship between logical units and the first physical unit. This prevents new data from being accidentally re-stored in the first physical unit.

In an embodiment, the memory control circuit 24 may detect an error event related to at least one physical unit (i.e., the first physical unit) in the memory module 122. For example, the error event may include at least one of a read error event, a write error event, and an erase error event related to the first physical unit.

In an embodiment, a read error event related to the first physical unit may reflect that a read operation performed by the memory module 122 on the first physical unit has encountered an error at a certain point in time. For example, if the bit error rate (BER) of the data read from the first physical unit is too high (e.g., exceeding a threshold value) and causes the data to be unable to be successfully decoded by the encoding circuit 23 (i.e., unable to correct all errors within the data), the memory control circuit 24 may determine that a read error event related to the first physical unit has been detected. In an embodiment, data that cannot be successfully decoded by the encoding circuit 23 is also referred to as uncorrectable data. However, a read error event related to the first physical unit may also reflect other types of read errors related to the first physical unit, and the disclosure is not limited thereto.

In an embodiment, a write error event related to the first physical unit may reflect that a write operation performed by the memory module 122 on the first physical unit has encountered an error at a certain point in time. For example, during the execution of a write operation on the first physical unit, if at least some of the memory cells within the first physical unit consistently fail to pass the verification of the write verification voltage, the memory control circuit 24 may determine that a write error event related to the first physical unit has been detected. However, a write error event related to the first physical unit may also reflect other types of write errors related to the first physical unit, and the disclosure is not limited thereto.

In an embodiment, an erase error event related to the first physical unit may reflect that an erase operation performed by the memory module 122 on the first physical unit has encountered an error at a certain point in time. For example, during the execution of an erase operation on the first physical unit, if at least some of the memory cells within the first physical unit consistently fail to pass the verification of the erase verification voltage, the memory control circuit 24 may determine that an erase error event related to the first physical unit has been detected. However, an erase error event related to the first physical unit may also reflect other types of erase errors related to the first physical unit, and the disclosure is not limited thereto.

In an embodiment, according to the detected error event, the memory control circuit 24 may classify the first physical unit as a first-type storage region. At the same time, the memory control circuit 24 may associate the first physical unit with the first-type storage region 33.

In an embodiment, according to the detected error event, the memory control circuit 24 may record state description information related to the error event. After classifying the first physical unit as a first-type storage region, the memory control circuit 24 may perform a storage region verification on the first physical unit classified as the first-type storage region according to the state description information.

For example, if the result of the storage region verification meets a specific condition (also referred to as a recovery conditions), the memory control circuit 24 may reclassify the first physical unit as a third-type storage region. The recovery conditions is used to indicate that, under the current specified condition, the cause of the error event related to the first physical unit is not due to the first physical unit itself. However, if the result of the storage region verification does not meet the recovery conditions (indicating that the current operating environment of the first physical unit is a normal operating environment), the memory control circuit 24 may determine that the first physical unit is a second-type storage region.

In an embodiment, the state description information related to the error event includes environmental information (also referred to as first environmental information). The first environmental information may reflect the characteristics of the operating environment (also referred to as the first environmental characteristics) of a storage device 10 at the time when the error event related to the first physical unit is detected.

For example, the first environmental characteristics may reflect whether the operating environment of the storage device 10 at the time of detecting the error event related to the first physical unit is a normal operating environment or an extreme operating environment. Generally, compared to a normal operating environment, at least some of the physical units in the memory module 122 are more prone to operational abnormalities under an extreme operating condition.

In an embodiment, during the storage region verification performed on the first physical unit classified as a first-type storage region, the memory control circuit 24 may determine whether the first environmental information meets a specific condition (also referred to as an environmental control conditions). Specifically, the environmental control conditions includes, but are not limited to, control conditions corresponding to extreme operating environments and control conditions corresponding to normal operating environments.

In an embodiment, if the first environmental information meets the environmental control conditions, it indicates that when the error event related to the first physical unit is detected, the current operating environment of the storage device 10 is a normal operating environment. If the first environmental information does not meet the environmental control conditions, it indicates that when the error event related to the first physical unit is detected, the current operating environment of the storage device 10 is not a normal operating environment. Alternatively, from another perspective, if the first environmental information does not meet the environmental control conditions, it indicates that when the error event related to the first physical unit is detected, the current operating environment of the storage device 10 is an extreme operating environment.

In an embodiment, the first environmental information may include an environmental parameter value (also referred to as the first environmental parameter value). The first environmental parameter value may reflect the first environmental characteristics. For example, the first environmental parameter value may be at least one of a temperature value (also referred to as the first temperature value), a vibration amplitude value (also referred to as the first vibration amplitude value), and a vibration frequency value (also referred to as the first vibration frequency value). The first temperature value may reflect the current temperature of the storage device 10 when the error event related to the first physical unit is detected. The first vibration amplitude value may reflect the current vibration amplitude of the storage device 10 when the error event related to the first physical unit is detected. The first vibration frequency value may reflect the current vibration frequency of the storage device 10 when the error event related to the first physical unit is detected.

It should be noted that the first environmental information may also include other types of environmental parameter values, as long as they may reflect the current environmental characteristics (i.e., the first environmental characteristics) of the storage device 10 when the error event related to the first physical unit is detected.

In an embodiment, the memory control circuit 24 may determine whether the first environmental parameter value falls within a specific value range (also referred to as a normal value range). Taking the first environmental parameter value as a temperature value, for example, the normal value range may be between 0° C. and 60° C., and the disclosure is not limited thereto.

Specifically, if the first environmental parameter value falls within the normal value range, the memory control circuit 24 may determine that the first environmental information meets the environmental control conditions. However, if the first environmental parameter value does not fall within the normal value range, the memory control circuit 24 may determine that the first environmental information does not meet the environmental control conditions.

In an embodiment, if the first environmental information does not meet the environmental control conditions (i.e., when the error event related to the first physical unit is detected, the current operating environment of the storage device 10 is an extreme operating environment), the memory control circuit 24 may determine that the result of the storage region verification meets the recovery conditions. Therefore, the memory control circuit 24 may reclassify the first physical unit as a third-type storage region.

It may be seen that, according to the method proposed by the above embodiments, by reclassifying the first physical unit as a third-type storage region when the first environmental information does not meet the environmental control conditions, it is possible to reduce (or eliminate) situations where, due to the operation of the storage device 10 in an extreme operating environment, an error event occurs in the first physical unit and causes the first physical unit, which may still be normally used under a normal operating environment, to be mistakenly marked as a second-type storage region. As a result, the accuracy of determining the second-type storage region may be improved through two levels of verification, thereby effectively extending the service life of the storage device 10 or the memory module 122.

In an embodiment, if the first environmental information meets the environmental control conditions (i.e., when the error event related to the first physical unit is detected, the current operating environment of the storage device 10 is a normal operating environment), the memory control circuit 24 may perform further verification on the first physical unit to decide whether to reclassify the first physical unit as a third-type storage region or directly determine the first physical unit as a second-type storage region according to the actual operating state of the first physical unit under the normal operating environment.

In an embodiment, if the first environmental information meets the environmental control conditions, the memory control circuit 24 may obtain another environmental information (also referred to as the second environmental information). The second environmental information may reflect the characteristics of the current operating environment of the storage device 10 (also referred to as the second environmental characteristics) during the execution of the storage region verification. For example, the second environmental characteristics may reflect whether the current operating environment of the storage device 10 during the execution of the storage region verification on the first physical unit is a normal operating environment or an extreme operating environment.

In an embodiment, the memory control circuit 24 may determine whether the second environmental information meets the environmental control conditions. If the second environmental information meets the environmental control conditions, it indicates that during the execution of the storage region verification on the first physical unit, the current operating environment of the storage device 10 is a normal operating environment. If the second environmental information does not meet the environmental control conditions, it indicates that during the execution of the storage region verification on the first physical unit, the current operating environment of the storage device 10 is not a normal operating environment. Alternatively, from another perspective, if the second environmental information does not meet the environmental control conditions, it indicates that during the execution of the storage region verification on the first physical unit, the current operating environment of the storage device 10 is an extreme operating environment.

In an embodiment, the second environmental information may include an environmental parameter value (also referred to as the second environmental parameter value). The second environmental parameter value may reflect the second environmental characteristics. For example, the second environmental parameter value may be at least one of a temperature value (also referred to as the second temperature value), a vibration amplitude value (also referred to as the second vibration amplitude value), and a vibration frequency value (also referred to as the second vibration frequency value). The second temperature value may reflect the current temperature of the storage device 10 during the execution of the storage region verification on the first physical unit. The second vibration amplitude value may reflect the current vibration amplitude of the storage device 10 during the execution of the storage region verification on the first physical unit. The second vibration frequency value may reflect the current vibration frequency of the storage device 10 during the execution of the storage region verification on the first physical unit.

It should be noted that, similar to the first environmental information, the second environmental information may also include other types of environmental parameter values, as long as they may reflect the current environmental characteristics (i.e., the second environmental characteristics) of the storage device 10 during the execution of the storage region verification on the first physical unit.

In an embodiment, the memory control circuit 24 may determine whether the second environmental parameter value falls within the normal value range. If the second environmental parameter value falls within the normal value range, the memory control circuit 24 may determine that the second environmental information meets the environmental control conditions. However, if the second environmental parameter value does not fall within the normal value range, the memory control circuit 24 may determine that the second environmental information does not meet the environmental control conditions.

In an embodiment, if the second environmental information does not meet the environmental control conditions (i.e., during the execution of the storage region verification on the first physical unit, the current operating environment of the storage device 10 is an extreme operating environment), the memory control circuit 24 may temporarily refrain from further processing the first physical unit. For example, the memory control circuit 24 may continue to classify the first physical unit as a first-type storage region until the second environmental information is detected to meet the environmental control conditions.

In an embodiment, if the second environmental information meets the environmental control conditions (i.e., during the execution of the storage region verification on the first physical unit, the current operating environment of the storage device 10 is a normal operating environment), the memory control circuit 24 may perform an access operation on the first physical unit under this environmental control conditions (i.e., the normal operating environment) according to the state description information. Then, the memory control circuit 24 may determine whether the result of the storage region verification meets the recovery conditions according to the result of the access operation performed under this environmental control conditions (i.e., the normal operating environment). If the result of the storage region verification meets the recovery conditions, the memory control circuit 24 may reclassify the first physical unit as a third-type storage region. Alternatively, if the result of the storage region verification does not meet the recovery conditions, the memory control circuit 24 may directly determine the first physical unit as a second-type storage region.

In an embodiment, assume that the state description information related to the error event reflects that the error event is a read error event related to the first physical unit. After determining that the second environmental information meets the environmental control conditions, during the execution of the storage region verification on the first physical unit, the memory control circuit 24 may perform a read operation (i.e., the access operation) on the first physical unit according to the state description information to read data from the first physical unit.

In an embodiment, during the storage region verification, if the executed read operation reads uncorrectable data from the first physical unit, the memory control circuit 24 may further perform an access test (also referred to as a first-type access test) on the first physical unit.

For example, the first-type access test includes at least two of a write verification test, a read verification test, and an erase verification test. The write verification test includes performing at least one data write test on the first physical unit. The read verification test includes performing at least one data read test on the first physical unit. The erase verification test includes performing at least one data erase test on the first physical unit.

In an embodiment, during the execution of the first-type access test, the memory control circuit 24 may sequentially perform a data erase test, a data write test, and a data read test on the first physical unit. Alternatively, during the execution of the first-type access test, the memory control circuit 24 may sequentially perform just a data erase test and a data write test on the first physical unit, or just a data write test and a data read test, and the disclosure is not limited thereto.

In an embodiment, during the storage region verification, if the first-type access test does not fail (i.e., at least two of the executed write verification test, read verification test, and erase verification test pass the verification), it indicates that the first physical unit may be normally used under a normal operating environment. Therefore, the memory control circuit 24 may determine that the result of the storage region verification meets the recovery conditions. At the same time, the memory control circuit 24 may update a count value corresponding to the first physical unit. This count value may reflect the number of occurrences of each type of error event when the first physical unit operates under a normal operating environment. For example, the memory control circuit 24 may increment the count value by one to update the count value.

In an embodiment, during the storage region verification, if the first-type access test fails (i.e., the executed write verification test, read verification test, or erase verification test does not pass the verification), it indicates that the first physical unit indeed cannot be normally used under a normal operating environment. Therefore, the memory control circuit 24 may determine that the result of the storage region verification does not meet the recovery conditions and determine the first physical unit as a second-type storage region. Furthermore, the memory control circuit 24 may remove the association between the physical unit and the first-type storage region and prohibit any data write operation on the first physical unit.

In an embodiment, during the storage region verification, if the executed read operation does not read uncorrectable data from the first physical unit, it indicates that the first physical unit may be normally used under a normal operating environment. Therefore, the memory control circuit 24 may determine that the result of the storage region verification meets the recovery conditions and reclassify the first physical unit as a third-type storage region. The memory control circuit 24 may reclassify the physical unit as a third-type storage region and associate the physical unit with the spare region. At this time, the first physical unit is allowed to perform data write operations.

In an embodiment, assume that the state description information related to the error event reflects that the error event is an erase error event related to the first physical unit. After determining that the second environmental information meets the environmental control conditions, during the storage region verification performed on the first physical unit, the memory control circuit 24 may perform an erase operation (i.e., the access operation) on the first physical unit according to the state description information to erase the first physical unit.

In an embodiment, during the storage region verification, if the executed erase operation fails, it indicates that the first physical unit indeed cannot be normally used under a normal operating environment. Therefore, the memory control circuit 24 may determine that the result of the storage region verification does not meet the recovery conditions.

In an embodiment, during the storage region verification, if the executed erase operation does not fail and the count value corresponding to the first physical unit is the preset value, the memory control circuit 24 may determine that the result of the storage region verification meets the recovery conditions. At the same time, the memory control circuit 24 may update the count value corresponding to the first physical unit. For example, the memory control circuit 24 may increment the count value by one to update the count value. The preset value may be a specific value (e.g., “0”) or any value within a preset range, and the disclosure is not limited thereto.

It should be noted that the above count value can, to some extent, reflect the verification results of second-type storage region detection conducted by the storage device at different stages. For example, if no error event occurs during historical periods of second-type storage region verification for a certain first physical unit, or if an error event occurs but the first physical unit is determined to remain as a third-type storage region after further verification during its classification as a first-type storage region, the count value will always be “0.” Exemplarily, in this embodiment, if the preset value is set to “0” to represent a third-type storage region and set to a non-zero value (e.g., “1”) to represent a second-type storage region, then when the count value is equal to the preset value, the current first physical unit is determined to be a third-type storage region; otherwise, the current first physical unit is determined to be a second-type storage region.

In practical application scenarios, the method provided by the embodiments of this disclosure may be used to perform storage region detection on a certain physical unit while synchronously updating the count value during the detection process. Once the storage region detection process is completed, the size of the count value may be used to determine whether the physical unit is a second-type storage region.

In an embodiment, during the storage region verification, if the executed erase operation does not fail and the count value corresponding to the first physical unit is not the preset value, the memory control circuit 24 may further perform an access test (also referred to as a second-type access test) on the first physical unit. For example, the second-type access test includes a write verification test and a read verification test. For instance, during the execution of the second-type access test, the memory control circuit 24 may sequentially perform the write verification test and the read verification test on the first physical unit.

In an embodiment, during the storage region verification, if the second-type access test does not fail (i.e., the executed write verification test and read verification test both pass the verification), it indicates that the first physical unit may be normally used under a normal operating environment. Therefore, the memory control circuit 24 may determine that the result of the storage region verification meets the recovery conditions. At the same time, the memory control circuit 24 may update the count value corresponding to the first physical unit. For example, the memory control circuit 24 may increment the count value by one to update the count value.

In an embodiment, during the storage region verification, if the second-type access test fails (i.e., the executed write verification test or read verification test does not pass the verification), it indicates that the first physical unit indeed cannot be normally used under a normal operating environment. Therefore, the memory control circuit 24 may determine that the result of the storage region verification does not meet the recovery conditions.

In an embodiment, assume that the state description information related to the error event reflects that the error event is a write error event related to the first physical unit. After determining that the second environmental information meets the environmental control conditions, during the storage region verification performed on the first physical unit, the memory control circuit 24 may perform a write operation (i.e., the access operation) on the first physical unit according to the state description information to store data into the first physical unit.

In an embodiment, during the storage region verification, if the executed write operation fails, it indicates that the first physical unit indeed cannot be normally used under a normal operating environment. Therefore, the memory control circuit 24 may determine that the result of the storage region verification does not meet the recovery conditions.

In an embodiment, during the storage region verification, if the executed write operation does not fail and the count value corresponding to the first physical unit is the preset value, the memory control circuit 24 may determine that the result of the storage region verification meets the recovery conditions. At the same time, the memory control circuit 24 may update the count value corresponding to the first physical unit. For example, the memory control circuit 24 may increment the count value by one to update the count value.

In an embodiment, during the storage region verification, if the executed write operation does not fail and the count value corresponding to the first physical unit is not the preset value, the memory control circuit 24 may further perform an access test (also referred to as a third-type access test) on the first physical unit. For example, the third-type access test includes a read verification test. During the execution of the third-type access test, the memory control circuit 24 may perform the read verification test on the first physical unit.

In an embodiment, during the storage region verification, if the third-type access test does not fail (i.e., the executed read verification test passes the verification), it indicates that the first physical unit may be normally used under a normal operating environment. Therefore, the memory control circuit 24 may determine that the result of the storage region verification meets the recovery conditions. At the same time, the memory control circuit 24 may update the count value corresponding to the first physical unit. For example, the memory control circuit 24 may increment the count value by one to update the count value.

In an embodiment, during the storage region verification, if the third-type access test fails (i.e., the executed read verification test does not pass the verification), it indicates that the first physical unit indeed cannot be normally used under a normal operating environment. Therefore, the memory control circuit 24 may determine that the result of the storage region verification does not meet the recovery conditions.

In an embodiment, by performing the storage region verification on the first physical unit classified as a first-type storage region under a normal operating environment, it may be confirmed whether the first physical unit may be normally used under such condition. If the result of the storage region verification reflects that the first physical unit may be normally used under a normal operating environment, reclassifying the first physical unit as a third-type storage region may effectively extend the service life of the storage device 10. However, if the result of the storage region verification reflects that the first physical unit may no longer be normally used under a normal operating environment, the first physical unit may be further determined as a second-type storage region.

As a result, the continuous use of a first physical unit with poor health may be avoided, thus preventing adverse impacts on the operational stability of the storage device 10.

In an embodiment, the state description information related to the error event further includes error type information. The error type information may reflect the type of the error event. For example, the error type information may indicate whether the error event is one of a read error event, a write error event, or an erase error event related to the first physical unit.

In an embodiment, during the storage region verification performed on the first physical unit classified as a first-type storage region, the memory control circuit 24 may determine the type of the access operation to be performed on the first physical unit according to the error type information. For example, if the error type information indicates that the error event is a read error event related to the first physical unit, the memory control circuit 24 may decide that the access operation to be performed on the first physical unit during the storage region verification is a read operation. If the error type information indicates that the error event is an erase error event related to the first physical unit, the memory control circuit 24 may decide that the access operation to be performed on the first physical unit during the storage region verification is an erase operation. Alternatively, if the error type information indicates that the error event is a write error event related to the first physical unit, the memory control circuit 24 may decide that the access operation to be performed on the first physical unit during the storage region verification is a write operation.

It may be seen that, through the method provided by the above embodiments, dynamically determining the type of access operation to be performed on the first physical unit during the storage region verification according to the error type information may effectively improve the accuracy of the storage region verification performed on the first physical unit. Compared to using a single type (or fixed type) of verification mechanism to perform standardized operational verification on the first physical unit, dynamically determining or adjusting the type of access operation performed on the first physical unit during the storage region verification may effectively improve the accuracy of verification for different types of possible error events.

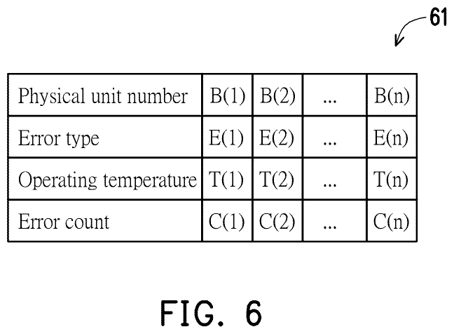

FIG. 6 is a schematic diagram of the state description information related to an error event according to an embodiment of the disclosure. Please refer to FIG. 6. In an embodiment, the memory control circuit 24 may establish a table 61. The table 61 may be used to record the state description information corresponding to multiple physical units in the memory module 122. For example, the state description information corresponding to the first physical unit may include information B (i), E (i), T (i), and C (i). Information B (i) may reflect the physical unit number of the first physical unit. Information E (i) (i.e., the error type information) may reflect the type of the most recent error event related to the first physical unit. Information T (i) (i.e., the first environmental information) may reflect the characteristics of the operating environment (e.g., temperature) of the storage device 10 when the error event related to the first physical unit is detected. Additionally, information C (i) may reflect the count value corresponding to the first physical unit.

In an embodiment, the memory control circuit 24 may update at least part of the information in table 61 (e.g., updating information E (i) and T (i)) according to the detected error event related to the first physical unit. In an embodiment, the memory control circuit 24 may perform the various aforementioned operations according to the information in table 61. The details of the related operations have already been described in detail above and will not be repeated here. Additionally, the information T (i) in table 61 may also be used to record other types of environmental parameter values, such as vibration amplitude values or vibration frequency values, and the disclosure is not limited thereto.

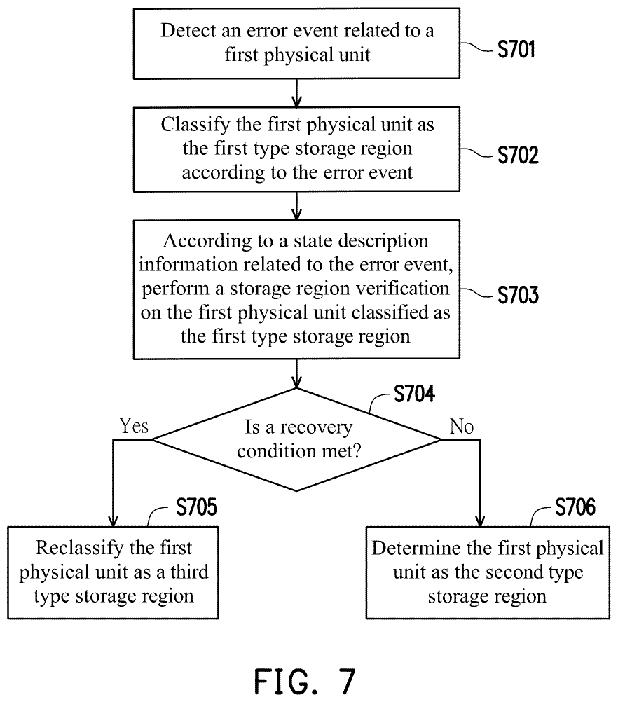

FIG. 7 is a flowchart illustrating the storage region management method according to an embodiment of the disclosure. Please refer to FIG. 7. The storage region management method provided by this embodiment specifically includes the following steps:

In step S701, an error event related to the first physical unit is detected.

In step S702, according to the error event, the first physical unit is classified as a first-type storage region.

In step S703, according to the state description information related to the error event, a storage region verification is performed on the first physical unit classified as the first-type storage region.

In step S704, according to the result of the storage region verification, whether the first physical unit classified as the first-type storage region meets the recovery conditions is determined.

In step S705, if the result of the storage region verification meets the recovery conditions, the first physical unit is reclassified as a third-type storage region.

In step S706, if the result of the storage region verification does not meet the recovery conditions, the first physical unit is determined as a second-type storage region.

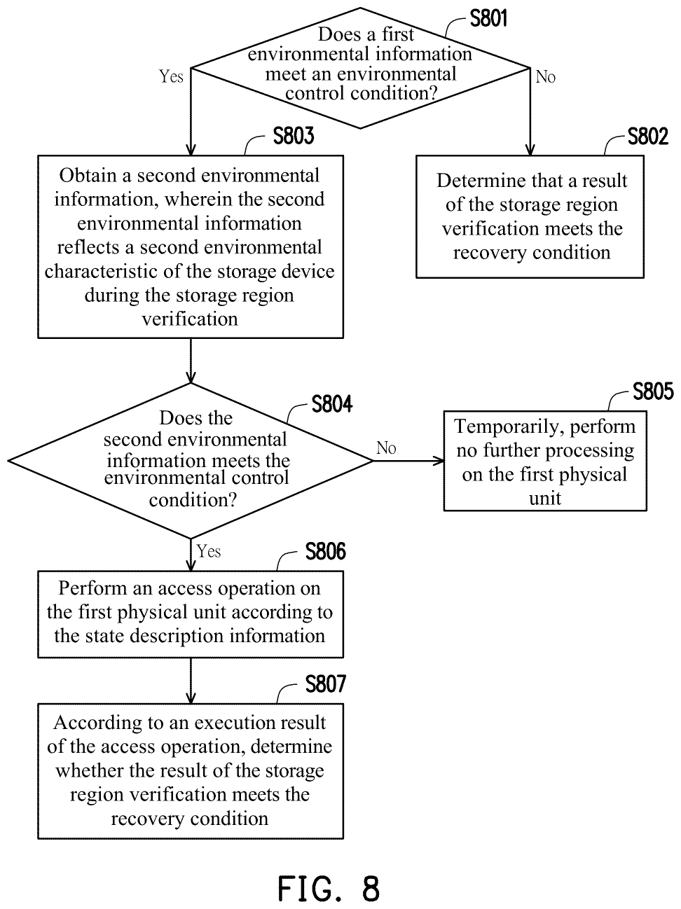

FIG. 8 is a flowchart illustrating the storage region management method according to an embodiment of the disclosure. Please refer to FIG. 8. The storage region management method provided by this embodiment further includes the following steps:

In step S801, whether the first environmental information in the state description information meets the environmental control conditions is determined.

In step S802, if the first environmental information does not meet the environmental control conditions, the result of the storage region verification is determined to meet the recovery conditions.

In step S803, if the first environmental information meets the environmental control conditions, the second environmental information is obtained, where the second environmental information reflects the second environmental characteristics of the storage device during the execution of the storage region verification.

In step S804, whether the second environmental information meets the environmental control conditions is determined.

In step S805, if the second environmental information does not meet the environmental control conditions, further processing on the first physical unit is temporarily halted.

In step S806, if the second environmental information meets the environmental control conditions, an access operation is performed on the first physical unit according to the state description information.

In step S807, according to the execution result of the access operation, whether the result of the storage region verification meets the recovery conditions is determined.

In an embodiment, if the result of the storage region verification meets the recovery conditions, the first physical unit is reclassified as a third-type storage region.

In an embodiment, the first physical unit classified as the first-type storage region and the first physical unit determined as the second-type storage region are both not allowed to perform data write operations, and the storage region management method further includes: if the first physical unit is reclassified as the third-type storage region, the first physical unit is allowed to perform the data write operation.

In an embodiment, the state description information includes the first environmental information, and the first environmental information is used to reflect the first environmental characteristics of the storage device when the error event related to the first physical unit is detected.

In an embodiment, the access operation is a read operation, and determining whether the result of the storage region verification meets the recovery conditions according to the execution result of the access operation includes the following steps. If the read operation reads uncorrectable data from the first physical unit, a first-type access test is performed on the first physical unit, where the first-type access test includes at least two of a write verification test, a read verification test, and an erase verification test. If the first-type access test does not fail, the result of the storage region verification is determined to meet the recovery conditions, and the count value corresponding to the first physical unit is updated. If the first-type access test fails, the result of the storage region verification is determined not to meet the recovery conditions. If the read operation does not read uncorrectable data from the first physical unit, the result of the storage region verification is determined to meet the recovery conditions.

In an embodiment, the access operation is an erase operation, and determining whether the result of the storage region verification meets the recovery conditions according to the execution result of the access operation includes the following steps. If the erase operation fails, the result of the storage region verification is determined not to meet the recovery conditions. If the erase operation does not fail and the count value corresponding to the first physical unit is the preset value, the result of the storage region verification is determined to meet the recovery conditions, and the count value corresponding to the first physical unit is updated. If the erase operation does not fail and the count value corresponding to the first physical unit is not the preset value, a second-type access test is performed on the first physical unit, where the second-type access test includes a write verification test and a read verification test. If the second-type access test does not fail, the result of the storage region verification is determined to meet the recovery conditions, and the count value corresponding to the first physical unit is updated. If the second-type access test fails, the result of the storage region verification is determined not to meet the recovery conditions.

In an embodiment, the access operation is a write operation, and determining whether the result of the storage region verification meets the recovery conditions according to the execution result of the access operation includes the following steps. If the write operation fails, the result of the storage region verification is determined not to meet the recovery conditions. If the write operation does not fail and the count value corresponding to the first physical unit is the preset value, the result of the storage region verification is determined to meet the recovery conditions, and the count value corresponding to the first physical unit is updated. If the write operation does not fail and the count value corresponding to the first physical unit is not the preset value, a third-type access test is performed on the first physical unit, where the third-type access test includes a read verification test. If the third-type access test does not fail, the result of the storage region verification is determined to meet the recovery conditions, and the count value corresponding to the first physical unit is updated. If the third-type access test fails, the result of the storage region verification is determined not to meet the recovery conditions.

In an embodiment, the state description information further includes error type information, and the error type information reflects the type of the error event.

In an embodiment, the step of performing the storage region verification on the first physical unit classified as the first-type storage region according to the state description information related to the error event further includes: determining the type of the access operation according to the error type information.

In an embodiment, if no error event related to the first physical unit is detected, the first physical unit is determined as the third-type storage region.

However, the steps in FIG. 7 and FIG. 8 have been described in detail as above, and will not be further elaborated here. It is worth noting that the steps in FIG. 7 and FIG. 8 may be implemented as multiple program codes or circuits, and the disclosure is not limited thereto. In addition, the methods in FIG. 7 and FIG. 8 may be used in combination with the exemplary embodiments described above or used independently, and the disclosure is not limited thereto.

In summary, the storage region management method and the storage device provided by the disclosure allow the first physical unit to be initially classified as a first-type storage region before the first physical unit is finally determined as a second-type storage region. Once the operating environment becomes relatively stable (e.g., returns to a normal operating environment), the storage region verification is performed on the first physical unit classified as the first-type storage region to reclassify the first physical unit as a third-type storage region or determine the first physical unit as a second-type storage region. As a result, this method may effectively improve the traditional issue of a significant increase in the number of second-type storage regions due to the frequent operation of the storage device in extreme environments, which otherwise shortens the service life of the storage device, thereby achieving the beneficial technical effect of extending the service life of the storage device.

Finally, it should be noted that the above embodiments are provided to illustrate the technical solutions of the disclosure and are not intended to limit them. Although the disclosure has been described in detail with reference to the above embodiments, a person having ordinary skill in the art should understand that modifications to the technical solutions described in the embodiments or equivalent replacements of some or all of the technical features may still be made. Such modifications or replacements do not depart from the essence of the corresponding technical solutions within the scope of the embodiments of the disclosure.

What is claimed is:

1. A storage region management method, used for a storage device, wherein the storage device comprises a memory module, and the memory module comprises a plurality of physical units, the storage region management method comprising:
detecting an error event related to the first physical unit of the plurality of physical units;
classifying the first physical unit as a first-type storage region according to the error event;
according to a state description information related to the error event, performing a storage region verification on the first physical unit classified as the first-type storage region; and
determining the first physical unit as a second-type storage region if the result of the storage region verification does not meet recovery conditions.

2. The storage region management method according to claim 1, further comprising:
reclassifying the first physical unit as a third-type storage region when the result of the storage region verification meets the recovery conditions.

3. The storage region management method according to claim 2, wherein the first physical unit classified as the first-type storage region and the first physical unit determined as the second-type storage region are both not permitted to perform data write operations, and the storage region management method further comprises:
allowing the data write operations to be performed on the first physical unit when the first physical unit is reclassified as the third-type storage region.

4. The storage region management method according to claim 1, wherein the state description information comprises first environmental information, and when an error event related to the first physical unit is detected, the first environmental information reflects the first environmental characteristic of the storage device.

5. The storage region management method according to claim 4, wherein according to the state description information related to the error event, performing the storage region verification on the first physical unit classified as the first-type storage region comprises:
determining whether the first environmental information meets the environmental control conditions; and
when the first environmental information does not meet the environmental control conditions, determining that the result of the storage region verification meets the recovery conditions.

6. The storage region management method according to claim 5, wherein according to the state description information related to the error event, performing the storage region verification on the first physical unit classified as the first-type storage region further comprises:
when the first environmental information meets the environmental control conditions, obtaining second environmental information, wherein the second environmental information reflects the second environmental characteristic of the storage device during the storage region verification;
determining whether the second environmental information meets the environmental control conditions;
when the second environmental information meets the environmental control conditions, performing an access operation on the first physical unit according to the state description information; and
determining whether the result of the storage region verification meets the recovery conditions according to 1 execution result of the access operation.

7. The storage region management method according to claim 6, wherein the access operation is a read operation, and determining whether the result of the storage region verification meets the recovery conditions according to the execution result of the access operation comprises:
when an uncorrectable data is read from the first physical unit through the read operation, performing a first-type access test on the first physical unit, wherein the first-type access test comprises at least two of write verification test, read verification test, and erase verification test;
when the first-type access test does not fail, determining that the result of the storage region verification meets the recovery conditions and updating the count value corresponding to the first physical unit;
when the first-type access test fails, determining that the result of the storage region verification does not meet the recovery conditions; and
when the uncorrectable data is not read from the first physical unit through the read operation, determining that the result of the storage region verification meets the recovery conditions.

8. The storage region management method according to claim 6, wherein the access operation is an erase operation, and determining whether the result of the storage region verification meets the recovery conditions according to the execution result of the access operation comprises:
when the erase operation fails, determining that the result of the storage region verification does not meet the recovery conditions;
when the erase operation does not fail and a count value corresponding to the first physical unit is a preset value, determining that the result of the storage region verification meets the recovery conditions and updating the count value corresponding to the first physical unit;
when the erase operation does not fail and the count value corresponding to the first physical unit is not the preset value, performing a second-type access test on the first physical unit, wherein the second-type access test comprises a write verification test and a read verification test;
when the second-type access test does not fail, determining that the result of the storage region verification meets the recovery conditions and updating the count value corresponding to the first physical unit; and
when the second-type access test fails, determining that the result of the storage region verification does not meet the recovery conditions.

9. The storage region management method according to claim 6, wherein the access operation is write operation, and determining whether the result of the storage region verification meets the recovery conditions according to the execution result of the access operation comprises:
when the write operation fails, determining that the result of the storage region verification does not meet the recovery conditions;
when the write operation does not fail and the count value corresponding to the first physical unit is a preset value, determining that the result of the storage region verification meets the recovery conditions and updating the count value corresponding to the first physical unit;
when the write operation does not fail and the count value corresponding to the first physical unit is not the preset value, performing a third-type access test on the first physical unit, wherein the third-type access test comprises a read verification test;
when the third-type access test does not fail, determining that the result of the storage region verification meets the recovery conditions and updating the count value corresponding to the first physical unit; and
when the third-type access test fails, determining that the result of the storage region verification does not meet the recovery conditions.

10. The storage region management method according to claim 1, further comprising:
when no error event related to the first physical unit of the plurality of physical units is detected, determining the first physical unit as a third-type storage region.

11. A storage device, comprising:
a connection interface, connected to a host system;
a memory module; and
a memory controller, connected to the connection interface and the memory module,
wherein the memory module comprises a plurality of physical units, and the memory controller is used to:
detect an error event related to the first physical unit of the plurality of physical units;
classify the first physical unit as a first-type storage region according to the error event;
according to a state description information related to the error event, perform a storage region verification on the first physical unit classified as the first-type storage region; and
determining the first physical unit as a second-type storage region if the result of the storage region verification does not meet recovery conditions.

12. The storage device according to claim 11, wherein when the result of the storage region verification meets the recovery conditions, the first physical unit is reclassified as a third-type storage region.

13. The storage device according to claim 12, wherein the first physical unit classified as the first-type storage region and the first physical unit determined as the second-type storage region are both not permitted to perform data write operations, and the memory controller is further used to:
allowing the data write operations to be performed on the first physical unit when the first physical unit is reclassified as the third-type storage region.

14. The storage device according to claim 11, wherein the state description information comprises a first environmental information, and when an error event related to the first physical unit is detected, the first environmental information reflects the first environmental characteristic of the storage device.

15. The storage device according to claim 14, wherein according to the state description information related to the error event, the memory controller performing the storage region verification on the first physical unit classified as the first-type storage region comprises:
determining whether the first environmental information meets the environmental control conditions; and
when the first environmental information does not meet the environmental control conditions, determining that the result of the storage region verification meets the recovery conditions.

16. The storage device according to claim 15, wherein according to the state description information related to the error event, the memory controller performing the storage region verification on the first physical unit classified as the first-type storage region further comprises:
when the first environmental information meets the environmental control conditions, obtaining a second environmental information, the second environmental information reflecting the second environmental characteristic of the storage device during the storage region verification;
determining whether the second environmental information meets the environmental control conditions;
when the second environmental information meets the environmental control conditions, performing an access operation on the first physical unit according to the state description information; and
determining whether the result of the storage region verification meets the recovery conditions according to the execution result of the access operation.

17. The storage device according to claim 16, wherein the access operation is a read operation, and the memory controller determining whether the result of the storage region verification meets the recovery conditions according to the execution result of the access operation comprises:
when an uncorrectable data is read from the first physical unit through the read operation, performing a first-type access test on the first physical unit, wherein the first-type access test comprises at least two of a write verification test, a read verification test, and an erase verification test;
when the first-type access test does not fail, determining that the result of the storage region verification meets the recovery conditions and updating the count value corresponding to the first physical unit;
when the first-type access test fails, determining that the result of the storage region verification does not meet the recovery conditions; and
when the uncorrectable data is not read from the first physical unit through the read operation, determining that the result of the storage region verification meets the recovery conditions.

18. The storage device according to claim 16 wherein the access operation is an erase operation, and according to the execution result of the access operation, the memory controller determining whether the result of the storage region verification meets the recovery conditions comprises:
when the erase operation fails, determining that the result of the storage region verification does not meet the recovery conditions;
when the erase operation does not fail and a count value corresponding to the first physical unit is a preset value, determining that the result of the storage region verification meets the recovery conditions and updating the count value corresponding to the first physical unit;
when the erase operation does not fail and the count value corresponding to the first physical unit is not the preset value, performing a second-type access test on the first physical unit, wherein the second-type access test comprises a write verification test and a read verification test;
when the second-type access test does not fail, determining that the result of the storage region verification meets the recovery conditions and updating the count value corresponding to the first physical unit; and
when the second-type access test fails, determining that the result of the storage region verification does not meet the recovery conditions.

19. The storage device according to claim 16, wherein the access operation is a write operation, and according to the execution result of the access operation, the memory controller determining whether the result of the storage region verification meets the recovery conditions comprises:
when the write operation fails, determining that the result of the storage region verification does not meet the recovery conditions;
when the write operation does not fail and a count value corresponding to the first physical unit is a preset value, determining that the result of the storage region verification meets the recovery conditions and updating the count value corresponding to the first physical unit;
when the write operation does not fail and the count value corresponding to the first physical unit is not the preset value, performing a third-type access test on the first physical unit, wherein the third-type access test comprises a read verification test;
when the third-type access test does not fail, determining that the result of the storage region verification meets the recovery conditions and updating the count value corresponding to the first physical unit; and
when the third-type access test fails, determining that the result of the storage region verification does not meet the recovery conditions.

20. A storage device, comprising:
a connection interface, connected to a host system;
a memory module; and
a memory controller, connected to the connection interface and the memory module,
wherein the memory module comprises a plurality of physical units, and the memory controller is used to:
determine the first physical unit as a third-type storage region when no error event related to the first physical unit of the plurality of physical units is detected.
